(19) United States
(12) Patent Application Publication
(10) Pub. No.: US 2019/0018409 A1
(43) Pub. Date: Jan. 17, 2019

(54) SYSTEMS AND METHODS FOR PROVIDING AN INTELLIGENT OVERRIDE FOR A DRIVING AUTOMATION SYSTEM

(71) Applicant: GM GLOBAL TECHNOLOGY OPERATIONS LLC, Detroit, MI (US)

(72) Inventors: James N. Nickolaou, Clarkston, MI (US); Jeremy A. Salinger, Southfield, MI (US); Charles A. Green, Canton, MI (US)

(73) Assignee: GM GLOBAL TECHNOLOGY OPERATIONS LLC, Detroit, MI (US)

(21) Appl. No.: 15/646,819

(22) Filed: Jul. 11, 2017

(51) Int. Cl. G05D 1/00; G05D 1/02; B60W 50/16

(52) U.S. Cl. CPC G05D 1/0061; B60W 2050/143; B60W 50/16; G05D 1/0274

(57) ABSTRACT

Methods are provided for intelligently overriding a driving automation system for a vehicle. The method first identifies a road feature ahead of the vehicle that requires overriding the engaged driving automation system. A deceleration zone is calculated for the vehicle prior to reaching the road feature and a transition zone is identified for the vehicle to pass through while under driver control. The driver is signaled to disengage the driving automation system as the vehicle approaches the deceleration zone and take control of the vehicle. If the driver fails to take control, the vehicle stops and shuts off the driving automation system. If the driver takes control, the vehicle passes through the transition zone and the driving automation system re-engages once the vehicle exits the transition zone.

### INTRODUCTION

A driving automation system is a system that senses its environment and drives a vehicle with little or no user input. A driving automation system detects its environment using sensing devices such as radar, lidar, image sensors, and the like. The driving automation system may further use information from global positioning systems (GPS) technology, navigation systems, vehicle-to-vehicle communication, vehicle-to-infrastructure technology, and/or drive-by-wire systems to navigate the vehicle.

Driving automation has been categorized into numerical levels ranging from Zero, corresponding to no automation with full human control, to Five, corresponding to full automation with no human control. Various automated driver-assistance systems, such as adaptive cruise control, correspond to lower automation levels, while true “driverless” vehicles correspond to higher automation levels.

Partially automated driving systems occasionally require input from the driver to continue automated driving. For example, turning or traveling through an intersection with the traffic signal may require the driver to take control of the vehicle for a brief period.

Accordingly, it is desirable to provide systems and methods that intelligently support driver override of a driving automation system. Furthermore, other desirable features and characteristics of the present invention will become apparent from the subsequent detailed description and the appended claims, taken in conjunction with the accompanying drawings and the foregoing technical field and background.

### SUMMARY

A method is provided for intelligently overriding a driving automation system for a vehicle. The method comprises identifying a road feature ahead of the vehicle with an engaged driving automation system, where the road feature requires overriding the engaged driving automation system for the vehicle; calculating a deceleration zone for the vehicle prior to the road feature; identifying a transition zone for the vehicle to pass through the road feature while under the control of a driver; signaling the driver of the need to disengage the driving automation system as the vehicle approaches the deceleration zone; requiring the driver to acknowledge the signal to disengage the driving automation system and take control of the vehicle; stopping the vehicle and shutting off the driving automation system if the driver fails to positively acknowledge the signal to disengage the driving automation system; passing the vehicle through the transition zone under control of the driver; and re-engaging the driving automation system once the vehicle exits the transition zone.

A system is provided for intelligently overriding a driving automation system for vehicle. The system comprises: an autonomous vehicle with a driving automation system; a sensing device on board the vehicle that identifies road features requiring overriding the engaged driving automation system for the vehicle; a processor on board the vehicle that calculates a deceleration zone for the vehicle prior to the road feature; and a signal system on board the vehicle that alerts the driver of the need to disengage the driving automation system and take control of the vehicle as the vehicle approaches the deceleration zone.

### BRIEF DESCRIPTION OF THE DRAWINGS

The present invention will hereinafter be described in conjunction with the following drawing figures, wherein like numerals denote like elements, and

FIG. 1 is a functional block diagram illustrating a vehicle equipped with a driving automation system having a passenger management system, in accordance with various embodiments;

FIG. 2 is a dataflow diagram illustrating a driving automation system of the vehicle equipped with a driving automation system, in accordance with various embodiments;

FIG. 3 is a diagram of a turn protocol of the intelligent override for a driving automation system, in accordance with various embodiments;

FIG. 4 is a diagram of an intersection protocol of the intelligent override for a driving automation system, in accordance with various embodiments; and

FIG. 5 is a flowchart of the detailed method of the intelligent override for a driving automation system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

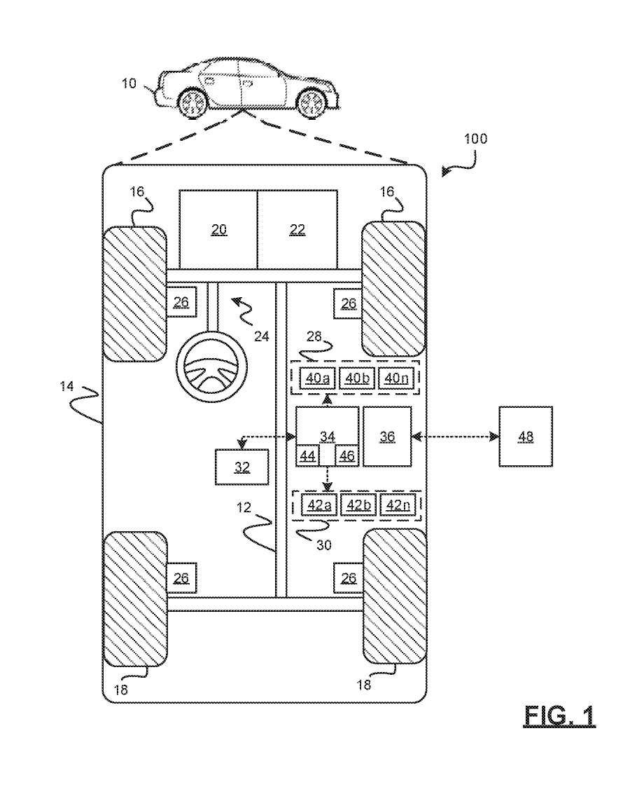

With reference to FIG. 1, an intelligent override system for a driving automation system is shown generally at 100 and is associated with a vehicle 10 in accordance with various embodiments. In general, the intelligent override system 100 determines that the vehicle 10 is approaching a road feature that requires overriding of an engaged driving automation system function and signals the driver of the vehicle 10 that automation is no longer available and that the driver needs to take over control of the vehicle 10.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

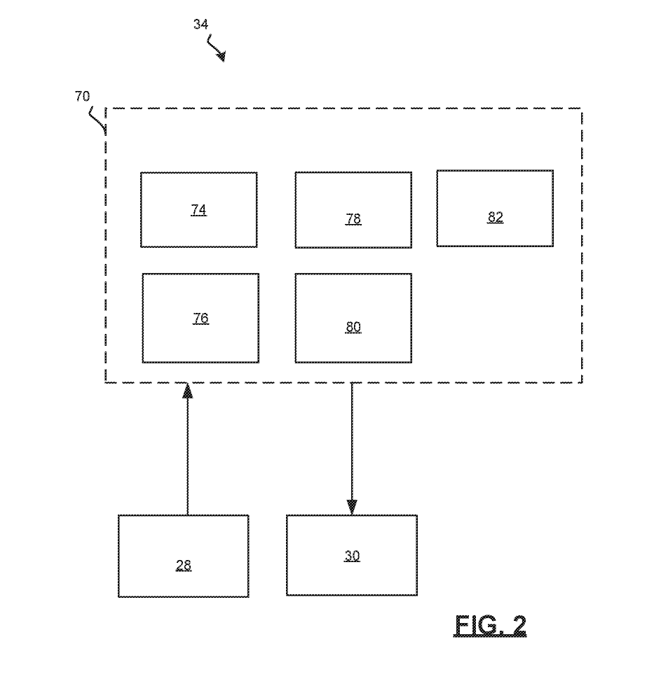

The vehicle 10 includes an intelligent override system 100 in accordance with various embodiments. The vehicle 10 is a vehicle equipped with a driving automation system 70 (FIG. 2); and the intelligent override system 100 is incorporated into or communicates with the driving automation system 70 as will be described in more detail below. The vehicle 10 equipped with a driving automation system 70 is, for example, a vehicle that is automatically controlled to perform one or more driving maneuvers. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the driving automation system 70 has a so-called Level Two capability. A Level Two system indicates “partial automation,” referring to the driving mode-specific performance by a driving automation system of all aspects of the dynamic driving task, where a human driver is still expected to perform object and event detection and response. In a similar embodiment, the driving automation system 70 may have a Level Three capability, referring to the driving mode specific performance by an Automated Driving System (ADS) of the entire dynamic driving task, where a human driver may need to respond to a request to intervene in the case of a system failure or the vehicle leaving the automated driving operational design domain.

As shown, the vehicle 10 equipped with the driving automation system 70 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18.

The sensor system 28 includes one or more sensing devices 40a-40n that sense observable conditions of the exterior environment and/or the interior environment of the vehicle 10 equipped with the driving automation system 70. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The communication system 36 is configured to wirelessly communicate information to and from other entities 48, such as but not limited to, other vehicles (“V2V” communication) infrastructure (“V2I” communication), remote systems, and/or personal devices.). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the vehicle 10 equipped with the driving automation system 70. In various embodiments, the data storage device 32 stores defined maps of the navigable environment. In various embodiments, the defined maps may be predefined by and obtained from a remote system. For example, the defined maps may be assembled by the remote system and communicated to the vehicle 10 equipped with the driving automation system 70 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a microprocessor, any combination thereof, or generally any device for executing instructions. In some embodiments, the intelligent override logic of the present system may be implemented using field-programmable gate arrays (FPGA) or application specific integrated circuits (ASICS) instead of programmable devices. Further, the automated driving system and the intelligent override may be implemented using neural network circuits instead of sequential instructions.

The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10 equipped with the driving automation system 70.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10 equipped with the driving automation system 70, and generate control signals to the actuator system 30 to automatically control the components of the vehicle 10 equipped with the driving automation system 70 based on the logic, calculations, methods, and/or algorithms. Although only one controller 34 is shown in FIG. 1, embodiments of the vehicle 10 equipped with the driving automation system 70 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10 equipped with the driving automation system 70.

As shown in FIG. 2 with continued reference to FIG. 1, one or more instructions of the controller 34 are embodied in the intelligent override system 100 of the driving automation system 70 and, when executed by the processor 44, identifies a road feature that requires overriding the engaged driving automation system 70 for the vehicle 10 in various embodiments. The system signals a driver of the need to disengage the driving automation system 70 and the need to take control of the vehicle 10. Once the vehicle 10 has passed the road feature, the driving automation system 70 is reengaged.

In accordance with various embodiments, controller 34 implements the driving automation system 70. That is, suitable software and/or hardware components of controller 34 (e.g., processor 44 and computer-readable storage device 46) are utilized to provide a driving automation system 70 that is used in conjunction with vehicle 10.

In various embodiments, the instructions of the driving automation system 70 may be organized by function or system. For example, the driving automation system 70 can include an external environment sensing system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the computer vision system 74 synthesizes and processes sensor data associated with the environment of the vehicle 10. In various embodiments, the computer vision system 74 can incorporate information from multiple sensors, including but not limited to cameras, lidars, radars, and/or any number of other types of sensors.

In various embodiments, the positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

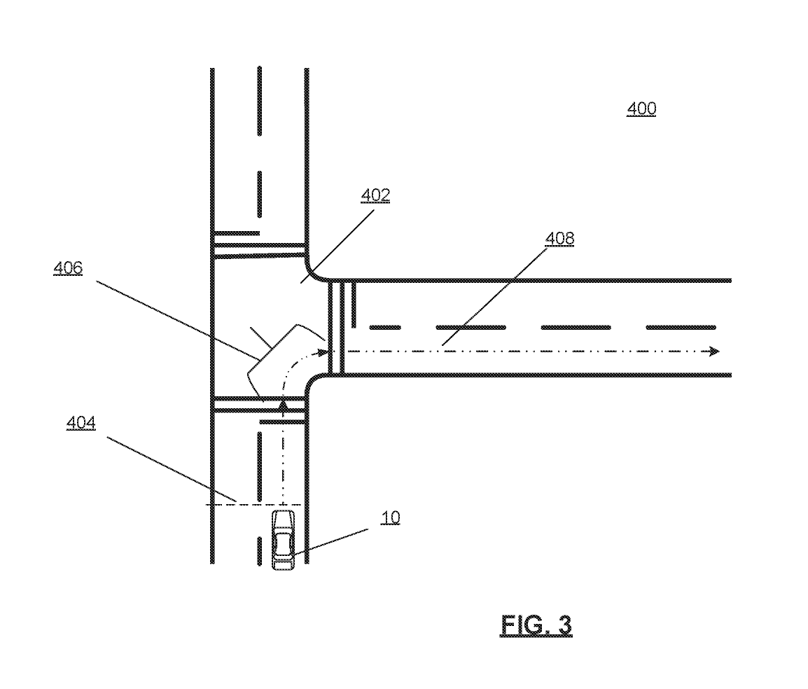

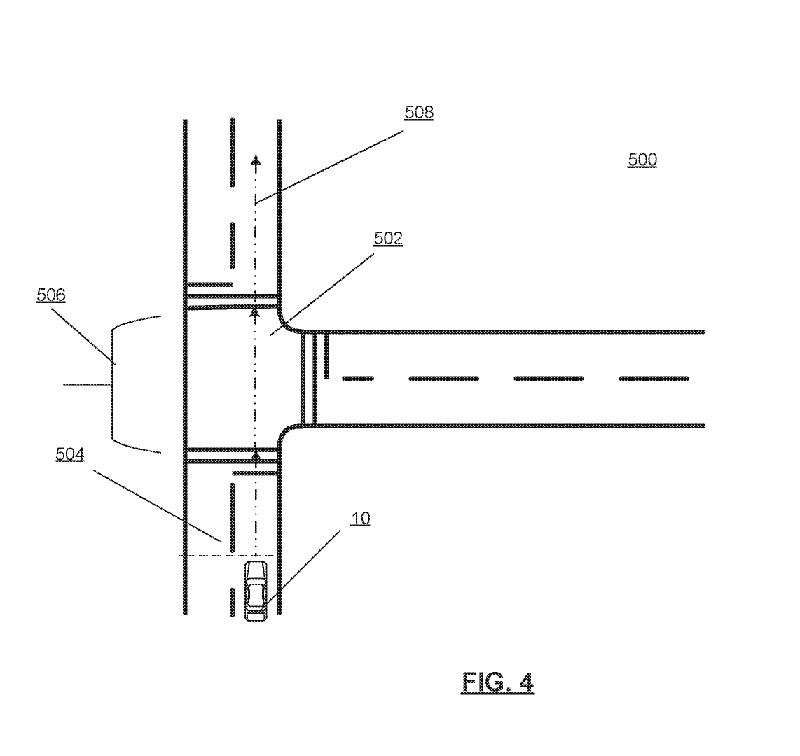

As mentioned briefly above, the system 100 of FIG. 1 determines when to engage and disengage the driving automation system 70. An “override” of the driving automation system is a request by the driver to take control of the vehicle. The request may be the driver grabbing the steering wheel, pressing the accelerator or applying the brakes. Once the driver overrides the driving automation system, the system may take back control at a later time. In contrast, an “disengagement” of the driving automation system is a cessation of all automated driving activity of the vehicle by the system. For example, a disengaged driving automation system may occur once the vehicle comes to a stop while awaiting the driver to assume control. All or parts of the system 100 may be included in an intelligent override module 82. For example, as shown in more detail with regard to FIGS. 3 and 4 and with continued reference to FIGS. 1-2, the diagrams are used to illustrate steps of a turn protocol 400 (FIG. 3) and a straight protocol 500 (FIG. 4) that may be performed by the intelligent override module 82. With initial reference to FIG. 3, a three-way intersection is detected as a road feature 402 ahead of the vehicle 10. The road feature may be detected with the sensor system 28 of the vehicle 10. Additionally, the road feature may be identified with an electronic map that is either electronically stored in the data storage device 32 of the vehicle 10 or remotely accessed through the vehicle's communication system 36.

At this point, the intelligent override module 82 determines that the road feature 402 requires overriding of the engaged driving automation system 70 by, for example, comparing the detected road feature to a predetermined list of road features that may be encountered by the vehicle 10. As the vehicle 10 approaches the intersection, intelligent override module 82 calculates a deceleration zone 404 (e.g., a first location and a second location) that allows the vehicle 10 adequate space to decelerate the vehicle to a stop before the intersection. The locations or points that define the deceleration zone 404 may be calculated based on the identified type of road feature, such as a major intersection, a traffic signal, a roundabout, a three-way intersection, etc. Additionally, the vehicle speed, weather conditions and road conditions may also be used to calculate the locations or points that define the deceleration zone 404.

As the vehicle 10 approaches the deceleration zone 404, the intelligent override module 82 activates an initial signal to the driver, for example by flashing a light (or other indication type) and/or provides additional non-visual alerting signal such as a vibrating seat or sound via control signals to alert the driver that the driving automation system 70 will disengage and to alert the driver of the need to take over control of the vehicle 10. As the vehicle 10 enters the deceleration zone 404, the intelligent override module 82 may modify the signal via control signals, for example, by changing the color of the flashing light and/or adding additional non-visual indications such as sounds or vibrations. As the vehicle 10 reaches the second point associated with a stop line at the end of the deceleration zone 404, the intelligent override module 82 may further modifies the signal via control signals. The intelligent override module 82 continues the signal until the driver acknowledges the indication by disengaging the driving automation system 70 and taking control of the vehicle 10. As can be appreciated, in alternative embodiments, the indication to the driver may instead or additionally include a text message shown on a console display in the vehicle 10, flashing lights, additional audible or haptic information, such as a speech alert or vibrations. In some embodiments, the driver disengages the driving automation system 70 and takes control of the vehicle 10 by pressing the accelerator. In some embodiments, the driver may maintain partial control of the vehicle by pressing the accelerator while the automated driving system retains control of the steering. In other embodiments, the driver may take control of the steering while the automated driving system maintains control of the accelerator. If the driver fails to disengage the driving automation system 70 within a specified time period, the vehicle 10 stops at the end of the deceleration zone, engages an emergency parking brake (EPB) and shuts off the driving automation system 70.

Once the driving automation system 70 has been disengaged and the driver is in control of the vehicle 10, the vehicle 10 is permitted to enter a transition zone 406. The transition zone 406 is the part of the vehicle trajectory that requires driver control. In this example, the vehicle trajectory is a turn at a T-intersection 402. After the vehicle 10 passes through the transition zone 406, the intelligent override module 82 detects that the vehicle 10 has reached the point or location and reengages the driving automation system 70 via a message or other signal to the driving automation system 70. Thereafter, the driving automation system 70 controls the vehicle 10 using partial or full automation.

With reference to FIG. 4 and with continued reference to FIGS. 1-3, the diagram is used to illustrate steps of a straight protocol 500 that may be performed by the intelligent override module 82. This protocol 500 may be similar to the protocol previously discussed for FIG. 3, for example, with the detection of a road feature of a T-intersection 502 and a determination of a deceleration zone 504 (e.g., a first location and a second location) for the vehicle 10. In this example, the intelligent override module 82 determines that the vehicle 10 is driving along a straight trajectory rather than turning at the intersection 502. The intelligent override module 82 operates in a similar manner as described above by controlling the vehicle 10 to slow in the deceleration zone, signaling the driver to disengage the driving automation system 70 and take control, the driver taking control through the transition zone 506 and the driving automation system 70 re-engaging after the vehicle 10 passes the detected road feature 502 and enters the zone 508.

In various embodiments, the intelligent override module 82 uses similar protocols for other types of road features encountered by the vehicle 10. For example, if the vehicle 10 encounters a known traffic light that is not visible to the sensor system 28, a traffic light that is red, a stop sign, a yield sign, or an unknown traffic signal, the intelligent override module 82 uses the turn protocol 400 as described in FIG. 3.

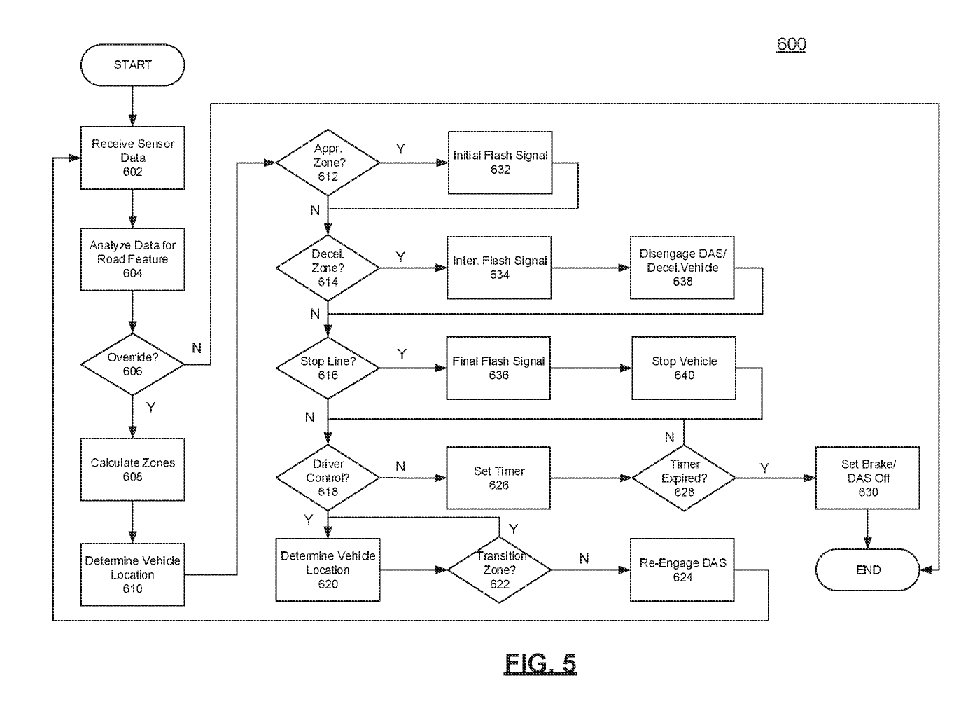

Referring now to FIG. 5, and with continued reference to FIGS. 1-4, a flowchart illustrates a detailed method 600 that can be performed by the intelligent override system 100 of FIG. 1 in accordance with the present disclosure. As can be appreciated in view of the disclosure, the order of operation within the method is not limited to the sequential execution as illustrated in FIG. 5, but may be performed in one or more varying orders as applicable and in accordance with the present disclosure. In various embodiments, the method 600 can be scheduled to run based on one or more predetermined events, and/or can run continuously during operation of the vehicle 10 equipped with the driving automation system (DAS) 70.

The method starts with the vehicle 10 receiving sensor data 602 and analyzing the sensor data to locate any upcoming road features 604. If an upcoming road feature requires an override of the DAS 606, the system will calculate the approaching zone, the deceleration zone, the stop line and the transition zone 608. The vehicle's 10 location is determined in relation to the calculated zones 610. As the vehicle 10 enters the approaching zone 612, the initial signal to the driver is activated 632. As the vehicle 10 enters the deceleration zone 614, the intermediate signal to the driver is activated 634 and the vehicle begins to decelerate 638. As the vehicle 10 reaches the stop line 616, the final signal to the driver is activated 636 and the vehicle stops 640. When the system transitions to a higher urgency signal, the previous signal will stop. Additionally, if the driver takes control of the vehicle prior to the vehicle coming to a stop, the signals will stop.

At this point, the system waits for the driver to initiate control of the vehicle 618. If the driver does not assume control, the method starts the timer 626. If the driver has not assumed control once the timer expires 628, the vehicle's parking brake is engaged and the DAS is shut off 630. Once the driver assumes control, the method determines the vehicle's location 620 and overrides the DAS 619. Once the vehicle exits the transition zone 622, the DAS is reassessed 624 to determine whether to re-engage the DAS. If the DAS is reengaged, the vehicle 10 continues its route and repeats the process if another road feature is encountered.

With reference to FIGS. 3-5, an example of operation of a current embodiment may include a vehicle equipped with a driving automation system with an engaged driving automation system approaching a T-intersection. The vehicle detects the upcoming intersection from an onboard electronic map and calculates a necessary deceleration zone based on the present speed of the vehicle. As the vehicle approaches the deceleration zone, the vehicle begins to slow down, an initial warning signal begins flashing to the driver and a pop-up message appears on a console display that reads “Automation Unavailable Ahead Please Take Over”. The driver presses on the accelerator which disengages the driving automation system. With the driver in control, the vehicle makes a turn at the intersection and passes through the transition zone. Once through this zone, the driver releases the steering wheel, takes his or her foot off the accelerator and automatically re-engages the driving automation system.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

What is claimed is:

1. A method for intelligently overriding a driving automation system for a vehicle, comprising:
identifying a road feature ahead of the vehicle with an engaged driving automation system, where the road feature requires overriding the engaged driving automation system for the vehicle;
calculating a deceleration zone for the vehicle prior to the road feature;
identifying a transition zone for the vehicle to pass through the road feature while under the control of a driver;
signaling the driver of the need to disengage the driving automation system as the vehicle approaches the deceleration zone;
requiring the driver to acknowledge the signal to disengage the driving automation system and take control of the vehicle;
stopping the vehicle and shutting off the driving automation system if the driver fails to positively acknowledge the signal to disengage the driving automation system;
passing the vehicle through the transition zone under control of the driver; and
re-engaging the driving automation system once the vehicle exits the transition zone.

2. The method of claim 1, where the road feature is identified with sensors on board the vehicle.

3. The method of claim 1, where the road feature is identified with an electronic map.

4. The method of claim 3, where the electronic map is stored on board the vehicle in an electronic readable medium.

5. The method of claim 3, where the electronic map is remotely accessed by the vehicle with an on-board communication system.

6. The method of claim 1, where the deceleration zone is calculated based on the type of road feature.

7. The method of claim 1, where the deceleration zone is calculated based on the vehicle speed.

8. The method of claim 1, where the deceleration zone is calculated based on weather conditions.

9. The method of claim 1, where the deceleration zone is calculated based on road conditions.

10. The method of claim 1, where an initial signal is used to signal the driver of the need to disengage the driving automation system.

11. The method of claim 10, where an intermediate signal activates as the vehicle enters the deceleration zone.

12. The method of claim 11, where a final signal activates as the vehicle reaches a stopping position within the deceleration zone.

13. The method of claim 10, where the signal comprises haptic vibrations.

14. The method of claim 10, where the signal comprises an audio signal.

15. The method of claim 10, where the signal comprises flashing lights.

16. The method of claim 1, where a text message shown on a console display is used to signal the driver of the need to disengage the driving automation system.

17. The method of claim 1, where the driver acknowledges the signal to disengage the driving automation system by pressing the accelerator of the vehicle.

18. The method of claim 1, further comprising:
engaging an emergency brake system (EBS) after stopping the vehicle if the driver fails to positively acknowledge the signal to disengage the driving automation system.

19. The method of claim 1, where the driving automation system is shut off if the driver fails to positively acknowledge the signal to disengage the driving automation system after a predetermined time period after stopping the vehicle.

20. A system for intelligently overriding a driving automation system for vehicle, comprising:
an autonomous vehicle with a driving automation system;
a sensing device on board the vehicle that identifies road features requiring overriding the engaged driving automation system for the vehicle;
a processor on board the vehicle that calculates a deceleration zone for the vehicle prior to the road feature; and
a signal system on board the vehicle that alerts the driver of the need to disengage the driving automation system and take control of the vehicle as the vehicle approaches the deceleration zone.
